(19) United States
(12) Patent Application Publication
(10) Pub. No.: US 2011/0250566 A1
(43) Pub. Date: Oct. 13, 2011

(54) PROCESS FOR FABRICATING TOOTH RESTORATION

(75) Inventor: Uriel Yarovesky, Thousand Oaks, CA (US)

(73) Assignee: DENTAL ILLUSIONS, INC., Agoura Hills, CA (US)

(21) Appl. No.: 12/756,357

(22) Filed: Apr. 8, 2010

(51) Int. Cl. A61C 13/083

(52) U.S. Cl. 433/212.1

(57) ABSTRACT

A process for fabricating a tooth restoration includes mixing a high fusing ceramic material, a low fusing ceramic material and a base material into a viscous liquid. The viscous liquid is applied to a tooth restoration base. Thereafter, the low fusing ceramic material is melted to adhere the high fusing ceramic material to the base. An overlay is then applied the high fusing ceramic material.

### BACKGROUND OF THE INVENTION

The present invention generally relates to dental restorations. More particularly, the present invention relates to a process for fabricating a dental restoration using both ceramic and composite materials.

A dental restoration is a material that has been placed in or over a prepared tooth to restore function and morphology when tooth structure has been lost due to decay or fracture or to improve the aesthetics of the tooth. Common indirect restorations include inlays, onlays, crowns, veneers, and bridges.

A crown may be constructed to restore an individual damaged tooth back to its original form and function, while a bridge may be utilized to replace one or more teeth. When fabricating a crown, the tooth is modified and prepared using special instruments to create what is referred to as an abutment. A copy of the tooth preparation is made by taking an impression. The impression is sent to the laboratory, where several fabrication phases and checkpoints within the dental lab contribute to the end result crown. This crown is then permanently cemented onto the abutment. A fixed bridge refers to a prosthesis that will span the area of the missing tooth, known as a pontic. The procedure involves the preparation of two or more abutment teeth, and an impression made thereof is sent to the dental laboratory for fabrication of the new tooth and overlays.

In the past, crowns, bridges and other restorations were primarily comprised of metals, such as gold, platinum, and the like. While serving adequately well, recently demand has increasingly shifted toward tooth colored restorations. This is due to the fact that the metal tooth restorations are unsightly.

When creating a tooth restoration, a metal substructure or base is fabricated in the dental lab. A tooth colored material, such as acrylic, ceramic material, or a composite material is formed over the metal substructure to form the false tooth or crown.

Acrylic restorations or metal have been virtually eliminated, however, due to the weakness of this material, and the lack of the ability of the material to properly adhere to the metal substructure.

Ceramic materials, such as porcelain, have many advantages including the ability to etch the ceramic and therefore make a relatively strong bond. The strength of the bond relies on both chemical and micromechanical properties that have been proven to be extremely successful. Certain ceramic technology (non-metallic) can provide strong support to overextended cases or bridge work. The ceramic material can be used in small or large restorations. Ceramic materials can be created to match tooth color, and is extremely strong and has the best surface longevity of the materials available for restoration.

However, there are some limitations and drawbacks to using ceramic materials. When using an all ceramic or porcelain restoration, without a metal base or substructure, the brittle porcelain material may fracture under heavy biting loads. Porcelain is more susceptible to fractures due to manufacturing default and design, incorrect adjustment methods by the dentist, functional interferences, and poor material selection. Ceramic materials must be fired and thermal cycled in high heat, which can cause warping and distortion of the fit of the metal substructures. Loss of margins due to oxidations can also occur when thermal cycling. In non-metallic restorations, margins are often poor. Moreover, porcelain has surface hardness that causes potential wear to opposing dentition, resulting in numerous problems. Ceramic restorations are considerably harder than natural teeth, and from an occlusal impact standpoint, porcelain in the mouth feels like what it is, glass. The porcelain material does not permit the dentist to modify at chairside, such as adding contacts, occlusal contact to a preferred place, or finishing the surface accurately for smoothness. In fact, it is difficult to get a good polished surface with a porcelain restoration. The self-adjusting amplitude of contact takes a long time, potentially causing trauma to dentition, periodontal membrane, or to the tooth itself. Finally, although ceramic materials can mimic tooth color, it is difficult to exactly match the color through fabrication as the color cannot be fully determined until the porcelain has been fired.

Composite resin usage started in the early 1980s, and since then major improvements in the quality of materials has been achieved. The advantages of using a composite material is that during fabrication, the color structure that will result is more easily viewed and determined, and thus it is possible to more accurately match the patient's teeth. If placed over a metal substructure, less stress is placed on the substructure due to manufacturing thermal cycling. Moreover, no marginal deterioration due to oxide convection, or warping of the frame occurs. In fact, composite has the most accurate margins, which are easily converted and modified. Composite material can be easily repairable out of the mouth, or directly in the mouth. Moreover, composite materials self-adjust over shorter periods of time with regard to amplitude of contact. Composite material is kinder to periodontal membranes and opposing dentition in wear, such that less trauma occurs in impact to opposing occlusion.

However, composite materials also have limitations. There is a limited ability of the composite material to adhere to the metal substructure base. There is also a limited ability for adhesion of composite bonding material once composite resin restoration has reached maximum polymerization. Cohesion failures occur in overextended situations, such as in large restorations when cusp support is needed. When composite materials are processed and maximum polymerization of resin has been achieved, a reduced ability to bond exists between the existing layer to the add-on layer. Bond strength is inadequate and limited to a small chemical bonding. Flexure of material during force application transmits forces to the restoration and tooth junction, causing loosening of the restoration and the potential of breakage and microleakage. Full coverage crowns where a large amount of material has to be used lack cusp support, and can cause fractures. In cases where multiple units with pontics are present, strength of the composite material is questionable.

With the introduction of fiber technology, strength of composite restorations has increased. However, it is very difficult to design and control the fiber structure to create ideal support for the composite, and if done incorrectly, can lead to hazardous fiber exposure in the mouth. In other instances, some of the fibers used actually produce a weakness in the material.

When preparing a tooth restoration designed to mimic the color and appearance of a natural tooth, the dental technician must decide between the materials available for the particular restoration to be formed and accept the drawbacks that the material inherently presents. For example, when selecting a ceramic material, which can be easily bonded to the metal substructure and provides a very strong material, the strength of the material can actually harm the surrounding teeth and gums of the patient, and also present adjustment concerns to the dentist. However, when using a composite material, the bonding strength to the metal substructure is questionable, and the potential for fractures is present, although the composite material is easier to match in color to the surrounding teeth and for the dentist to make adjustments to.

Accordingly, there is a continuing need for a dental restoration, and a method for fabricating the same, which utilizes the strengths of both the ceramic and composite materials. The present invention fulfills this need and provides other related advantages.

### SUMMARY OF THE INVENTION

The present invention includes a process for fabricating a tooth restoration. A high fusing ceramic material is first fired into a brittle structure. The fired high fusing ceramic material is then crushed into pieces. The crushed high fusing ceramic material is mixed with a low fusing ceramic material and a base material into a viscous liquid. The base material preferably comprises a glycerin-based viscous liquid. The viscous liquid is then applied to a tooth restoration base made from dentin or zirconia.

The low fusing ceramic material is then melted into the tooth restoration base to adhere the high fusing ceramic material thereto. Acid etching is applied to the high fusing ceramic material and along the exterior of the melted low fusing ceramic material. The acid etching creates crevices in the high fusing ceramic material and indentations in the low fusing ceramic material to create a highly bondable surface. Accordingly, an overlay is applied to such surface. The overlay is hardened from exposure to a high intensity light. The overlay is preferably made from enamel or another composite material.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart depicting the steps taken in accordance with the present invention for fabricating a tooth restoration;

FIG. 2 is a cross-sectional diagrammatic view of a crown tooth restoration bonded to a tooth (shown in phantom);

FIG. 3 is a cross-sectional view of a bridge tooth restoration fabricated in accordance with the present invention;

FIG. 4 is a cross-sectional view taken generally along line 4-4 of FIG. 3;

FIG. 5 is a flowchart illustrating an alternative set of steps for fabricating a tooth restoration in accordance with the present invention;

FIG. 6 is an enlarged cross-sectional view of the area 6 from FIG. 4;

FIG. 7 is a cross-sectional view of a tooth restoration using high fusing and low fusing porcelain, in accordance with the present invention;

FIG. 8 is a cross-sectional view of the tooth restoration of FIG. 7, illustrating the low fusion porcelain melted around the high fusing porcelain;

FIG. 9 illustrates acid etching the high fusion porcelain;

FIG. 10 is a cross-sectional view generally taken along the circle 10 of FIG. 9, illustrating the etched high fusion porcelain;

FIG. 11 is a cross-sectional view of an enamel composite bonded to the outside of the high fusion and low fusion porcelain; and

FIG. 12 is an enlarged cross-sectional view of the area designated by the circle 12 in FIG. 11, illustrating attachment of the enamel composite to the etched high fusion porcelain.

### DETAILED DESCRIPTION OF THE PREFERRED EMBODIMENTS

As shown in the accompanying drawings for purposes of illustration, the present invention resides in a process for fabricating a tooth restoration, such as a crown, bridge, etc., comprised of both ceramic and composite materials. The use of ceramic and composite materials, as discussed more fully herein, provides a tooth restoration which has the characteristics or benefits of both materials in a complimentary manner.

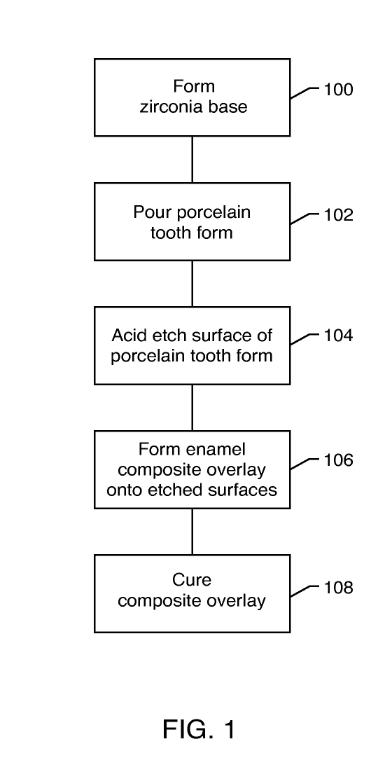

With reference to FIG. 1, in one embodiment of the invention a base is first formed (100). Typically, the base comprises a metallic material, such as zirconia. The materials available for forming a substrate or base and the method of doing so are well-known in the art.

Porcelain, or other ceramic material, is then poured, or otherwise formed, over the base so as to be built to what would correspond to the dentin level (102). Typically, the liquid porcelain material is poured or otherwise adhered over the substrate base and then fired, as is known in the art. It will also be appreciated by those skilled in the art that the ceramic or porcelain layer may be an all porcelain jacket or base without the metal or non-metal substrate or base. Such can be created with foil based refractory methods.

After the dentin layer of ceramic is built, it must be treated in order to properly bond to a composite material to be added thereto. Typically, the outer surface of the ceramic layer is sandblasted, and then acid etched (104). The outer surface can be exposed to hydrofluoric acid in order to form the acid etch step.

A composite material is then attached or overlaid onto the etched and treated surfaces of the ceramic layer (106). In dentistry, a composite is a tooth-colored material often used in place of amalgam. There are many proven composite systems on the market. They are generally classified as hybrids or microfills. Such composite materials are exceptional in appearance with respect to matching the appearance of adjacent teeth, have adequate wear characteristics, but are gentle to other teeth. The composite material that has been formed into the final shape of the false tooth or crown, etc., goes through a curing process specific for that composite (108). Typically, the composite material is cured under pressure and light.

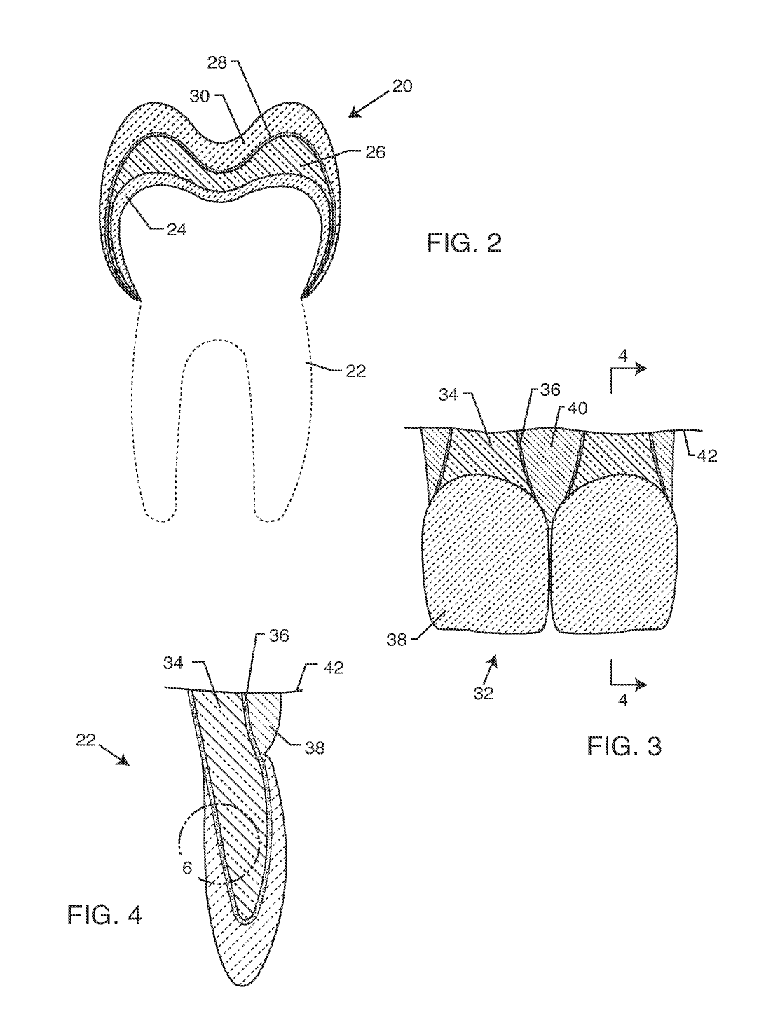

With reference to FIG. 2, an exemplary crown tooth restoration 20 created in accordance with the invention is shown. As described above, the tooth 22 is formed into an abutment in order to remove the broken portion of the tooth or the cavity, and also to make room for the crown 20 to be placed thereover. The crown 20 itself is fabricated from an impression of the treated tooth 22, typically in a dental lab or the like.

In accordance with the fabrication process described above, the crown 20 may include a base 24 or a substrate, typically comprised of a metallic material, such as zirconia. A layer of ceramic 26, such as porcelain, is then formed over the substrate base 24. As described above, the ceramic layer 26 may also comprise the base 24. Moreover, the ceramic layer 26 is formed as a substructure up to, but not limited to, the dentin layer of a corresponding tooth. The ceramic layer 26 provides support and strength of the restoration 20. An outer surface 28 of the ceramic layer 26 is treated, such as with sanding and acid etching, as described above. This presents a surface which can be readily bonded to.

The composite layer 30 is then attached to and formed over the ceramic layer 26. The composite layer 30 is formed into the outer appearance and shape of the tooth and is cured, as described above.

The restoration 20 has an internal surface that is able to be bonded in the mouth, such as onto the prepared tooth 22. The porcelain layer 26 adds support and is fracture resistant. The outer surface made of composite material 30 is kind to opposing dentition, and is easily correctable such as adding a contact, adjusting and polishing any marginal discrepancy, and can be very easily corrected due to the nature of the material. The composite material allows for self-adjusting of the contacts in a short time, as opposed to a porcelain material which does not.

With reference to FIGS. 3 and 4, an exemplary bridge tooth restoration 32 fabricated in accordance with the present invention is shown. Instead of a bridge, the tooth restoration 32 could also comprise an implantable restoration comprising a false tooth or the like.

This restoration 32 also includes a ceramic layer or substrate 34, this framework being fabricated according to standard procedure. The ceramic layer 34 once again forms an internal layer corresponding to a dentin layer of a tooth. After firing the ceramic/porcelain layer 34, the outer surface 36 thereof is treated, such as by sandblasting, etching, or other sequence to promote bonding. Composite material 38 is then formed over the ceramic layer 34 so as to mimic the appearance of the tooth. The ceramic layer 38 is then cured, as discussed above. With some composites, the composite material may actually be baked onto the ceramic layer 34.

In some instances, the patient's gum line recedes, such as due to age, disease, trauma, etc. Using the fabrication process of the present invention, a composite material 40 may be attached to an upper portion of the ceramic layer 34 which is to be disposed adjacent to the patient's gum line 42. The composite can be colored so as to match the gum tissue of the patient. The composite material 40 is formed in a manner so as to give the appearance of natural gum tissue, and cured. Thus, when the restoration 32 is implanted or otherwise attached to the mouth of the patient, a very natural appearance is provided.

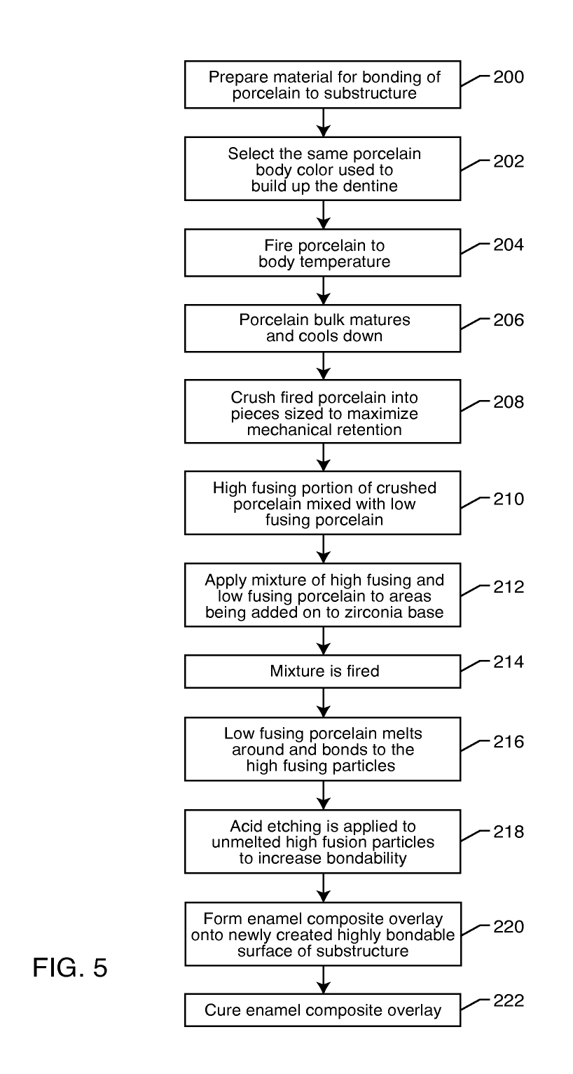

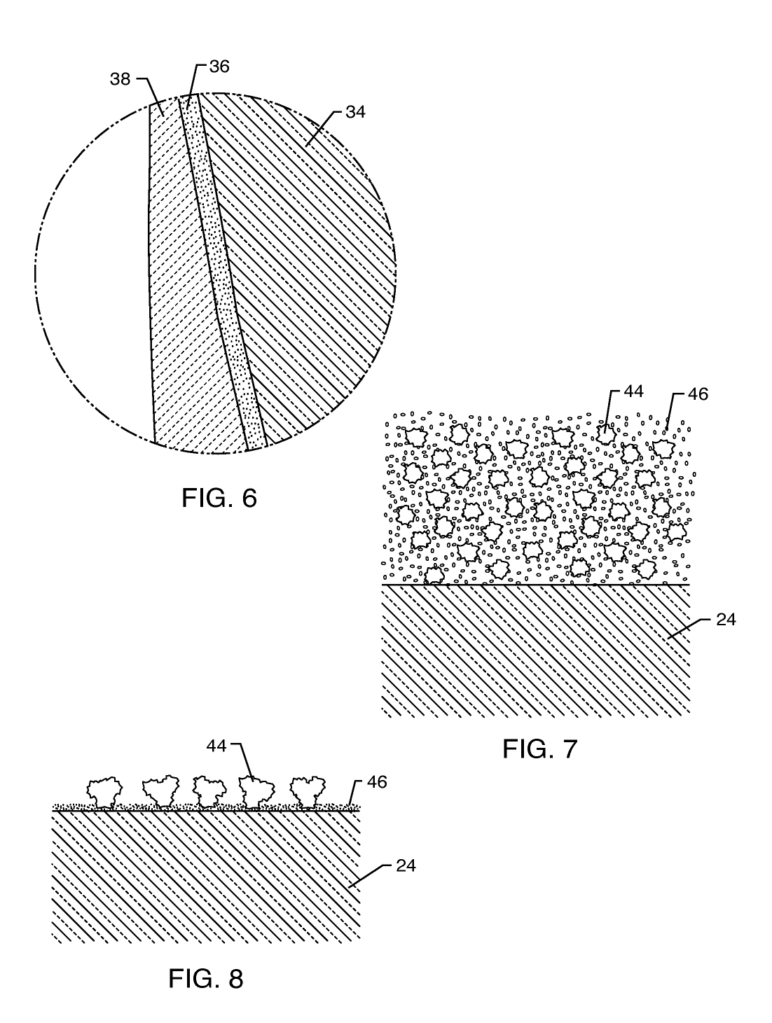

The flowchart of FIG. 5 illustrates an alternative process for fabricating tooth restorations in accordance with the present invention. This process enhances the bond between the composite material 38 and the outer surface 36 applied to the porcelain layer 34, as shown in FIG. 6. The process set forth in FIG. 5 and illustrated in FIGS. 7-12 creates larger mechanical and chemical retention of the composite material by the porcelain to maximize bondability. This process further prevents the composite from pulling away from the porcelain to ensure long term and reliable results. The first step is the preparation of the material for bonding of a porcelain to the substructure (200). This step includes forming the ceramic layer 26 as a substructure to the dentin layer to the base 24, as described above. The same porcelain body color is selected and used to buildup the dentin (202). A high fusing porcelain 44 is then fired to body temperature (204). The high fusing porcelain 44 cools down as the bulk matures (206). The fired high fusing porcelain 44 is then crushed into small pieces of a size of optimal mechanical retention (208). In a preferred embodiment, the high fusing porcelain 44 is crushed to the approximate size of sugar particles. This high fusing porcelain 44 is then mixed with a low fusing porcelain 46 and mashed together into a powder (210). The low fusing porcelain 46 is an extremely fine powder, similar to talcum powder, when mixed with the high fusing porcelain 44. A base material, such as a glycerin-based viscous liquid, is added to the high fusing porcelain 44 and the low fusing porcelain 46 to help facilitate homogenous mixing therein. The viscous liquid, including the high fusing porcelain 44 and the low fusing porcelain 46, is then applied to areas being added on the zirconia base (212). FIG. 7 illustrates the mixture of the relatively larger high fusing porcelain 44 intermixed with the relatively smaller pieces of low fusing porcelain 46 disposed along the exterior of the zirconia base 24 within the viscous liquid. Thereafter, the mixture is fired (214). Accordingly, the base material is burned out of the mixture during the firing step (214).

The low fusing porcelain 46 and the high fusing porcelain 44 create a monolithic structure during the firing step (214). The low fusing porcelain 46 has a melting point of 840° Celsius (“C”) while the high fusing porcelain 44 has a melting point of 950° C. The low fusing porcelain 46 accordingly melts into the base 24 for attachment thereto. The low fusing porcelain 46 also bonds to the high fusing porcelain 44 as generally shown in FIG. 8. The high fusing porcelain 44 does not melt during the firing step (216). Hence, the high fusing porcelain 44 is able to maintain its shape and structure. The resultant monolithic structure, when provided as a slab, creates a face for adhering other materials thereto. Acid etching is applied to the unmelted high fusing porcelain particles 44 and melted low fusing porcelain 46 to create an even more highly bondable surface (218). Preferably, hydrochloric acid is used to etch the high fusing porcelain 44 and the low fusing porcelain 46.

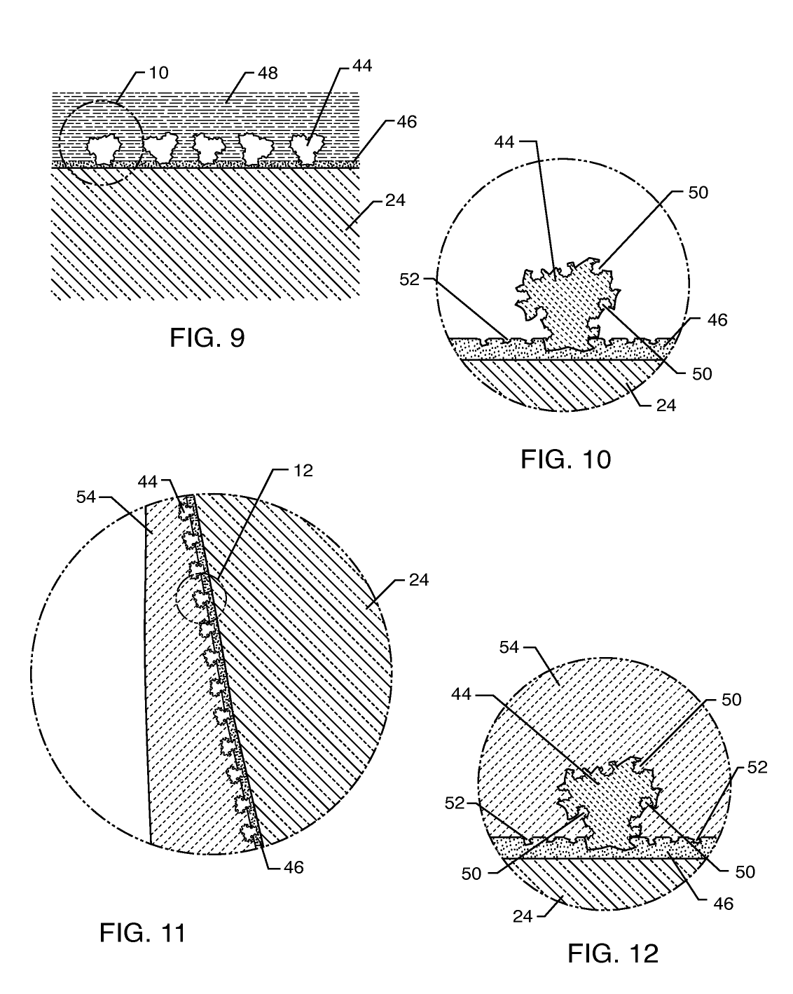

FIG. 9 illustrates a layer of acid 48 applied along the exterior of the monolithic structure that consists of the high fusing porcelain 44 and the low fusing porcelain 46. The acid 48 penetrates the exterior surface of the high fusing porcelain 44 to create an additional set of crevices 50 and forms a set of indentations 52 in the low fusing porcelain 46. As shown in FIG. 10, the crevices 50 and the indentations 52 provide additional micromechanical bonds for stronger bonding of the high fusing porcelain 44 and the low fusing porcelain 46 to an enamel composite 54 (FIG. 11). The enamel composite 54 is overlaid onto the newly created and highly bondable surface of substructure (220) comprising the high fusing porcelain 44 and corresponding crevices 50, and the low fusing porcelain 46 with the corresponding indentations 52. The enamel composite 54 is then hardened by curing (222). Preferably, the enamel composite 54 is cured by light polymerization. A high intensity light having a specific wavelength (e.g. 400-500 nanometers) is flashed on the clay-like enamel composite 54. The light activates the chemical structure therein to harden the enamel composite 54.

FIGS. 11 and 12 illustrate the enamel composite 54 overlaid on the high fusing porcelain 44 and the low fusing porcelain 46. The enlarged view of FIG. 12 best shows the enamel composite 54 engaged within the crevices 50 and the indentations 52 of the high fusing porcelain 44 and the low fusing porcelain 46, respectively. The interaction of the crevices 50 and the indentations 52 with the enamel composite 54 creates a strong bond among the materials.

All porcelain interior teeth, including pressables, zirconia, pjc, veneers, PFM, while in occlusion contact possess the potential of traumatic occlusal impact that than cause breakage. According to the present invention, after completing fabrication of the embodiments disclosed herein, all occlusal contacts on lingual of upper interiors will be slightly reduced and etched such that composite may be added to those areas of impact. Self-adjusting action takes place soon after cementation and reduces the potential of trauma due to a possible restricted envelope of function. Accordingly, corrections may be easily done at the chair side at any time.

It will be appreciated that the tooth restorations fabricated in accordance with the present invention provide the benefits of composite and ceramic materials, while being arranged in such a manner so as to reduce their drawbacks. More specifically, the inner ceramic material provides a very strong and reliable substructure which is resistant to fractures. The overlying composite layer is kind to opposing dentition so as not to create stress fractures or undue wear of opposing teeth, is easy to modify and cementable with conventional cement.

Although several embodiments of the present invention have been described in detail for purposes of illustration, various modifications may be made without departing from the scope and spirit of the invention. Accordingly, the invention is not to be limited, except as by the appended claims.

What is claimed is:

1. A process for fabricating a tooth restoration, comprising the steps of:
mixing a high fusing ceramic material, a low fusing ceramic material and a base material into a viscous liquid;
applying the viscous liquid to a tooth restoration base;
melting the low fusing ceramic material to adhere the high fusing ceramic material to the base; and
applying an overlay to the high fusing ceramic material.

2. The process of claim 1, including the step of firing the high fusing ceramic material.

3. The process of claim 1, including the step of crushing the high fusing ceramic material into pieces prior to the mixing step.

4. The process of claim 1, including the step of acid etching the high fusing ceramic material and the low fusing ceramic material.

5. The process of claim 1, wherein the base material comprises a glycerin-based viscous liquid.

6. The process of claim 1, including the step of curing the overlay.

7. The process of claim 6, wherein in curing step includes the step of exposing the overlay to a high intensity light.

8. The process of claim 1, wherein the overlay comprises an enamel or a composite material.

9. The process of claim 1, wherein the base comprises dentin or zirconia.

10. A process for fabricating a tooth restoration, comprising the steps of:
crushing a high fusing ceramic material into pieces;
mixing the high fusing ceramic material, a low fusing ceramic material and a base material into a viscous liquid;
applying the viscous liquid to a tooth restoration base;
melting the low fusing ceramic material to adhere the high fusing ceramic material to the base;
acid etching the high fusing ceramic material and the low fusing ceramic material; and
applying an overlay to the high fusing ceramic material.

11. The process of claim 10, including the step of firing the high fusing ceramic material.

12. The process of claim 10, including the step of curing the overlay.

13. The process of claim 12, wherein in curing step includes the step of exposing the overlay to a high intensity light.

14. The process of claim 10, wherein the base material comprises a glycerin-based viscous liquid.

15. The process of claim 10, wherein the overlay comprises an enamel or a composite material.

16. The process of claim 10, wherein the base comprises dentin or zirconia.

17. A process for fabricating a tooth restoration, comprising the steps of:
mixing a high fusing ceramic material, a low fusing ceramic material and a base material into a viscous liquid;
applying the viscous liquid to a tooth restoration base;
melting the low fusing ceramic material to adhere the high fusing ceramic material to the base;
acid etching the high fusing ceramic material and the low fusing ceramic material;
applying an overlay to the high fusing ceramic material; and
curing the overlay.

18. The process of claim 17, wherein in curing step includes the step of exposing the overlay to a high intensity light.

19. The process of claim 17, including the steps of firing the high fusing ceramic material and crushing the high fusing ceramic material into pieces prior to the mixing step.

20. The process of claim 17, wherein the base material comprises a glycerin-based viscous liquid, the overlay comprises an enamel or a composite material and the base comprises dentin or zirconia.
